(19) United States
(12) Patent Application Publication
(10) Pub. No.: US 2007/0160015 A1
(43) Pub. Date: Jul. 12, 2007

(54) Applying one or more session access parameters to one or more data sessions

(75) Inventor: Laurent Andriantsiferana, Valbone (FR)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/328,272

(22) Filed: Jan. 9, 2006

(51) Int. Cl. H04Q 7/24

(52) U.S. Cl. 370/338; 370/401

(57) ABSTRACT

In one embodiment, a method for applying one or more session access parameters to one or more data sessions includes obtaining one or more session connection parameters associated with a data session between a client device and a host coupled to each other via a network gateway and deriving one or more session flow filters from the session connection parameters associated with the data session.

### TECHNICAL FIELD OF THE INVENTION

The present invention generally relates to data sessions and more specifically relates to applying one or more session access parameters to one or more data sessions.

### BACKGROUND OF THE INVENTION

Network operators and service providers are exploring ways of providing users access to various services in third-generation and next-generation systems while, at the same time, policing access by the users to the various services. One such system is the Universal Mobile Telecommunications System (UMTS), which incorporates General Packet Radio Server (GPRS) technology set out by the Third Generation Partnership Project (3GPP).

### SUMMARY OF THE INVENTION

Particular embodiments of the present invention may reduce or eliminate problems and disadvantages associated with data sessions.

In one embodiment, In one embodiment, a method for applying one or more session access parameters to one or more data sessions includes obtaining one or more session connection parameters associated with a data session between a client device and a host coupled to each other via a network gateway and deriving one or more session flow filters from the session connection parameters associated with the data session.

Particular embodiments of the present invention provide one or more technical advantages. For example, particular embodiments provide enhanced control of network resources in UMTS networks. Particular embodiments allow Gateway GPRS Support Nodes (GGSNs) to grant particular resources to particular users. Particular embodiments allow GGSNs to deny provision of particular resources to particular users. In particular embodiments, only GGSNs need Traffic Flow Templates (TFTs). Particular embodiments may provide all, some, or none of these technical advantages. Particular embodiments may provide one or more other technical advantages, one or more of which may be readily apparent to a person skilled in the art from the figures, descriptions, and claims herein.

### BRIEF DESCRIPTION OF THE DRAWINGS

To provide a more complete understanding of the present invention and features and advantages thereof, references is made to the following description, taken in conjunction with the accompanying drawings, in which:

FIG. 1 illustrates an example Wideband Code Division Multiple Access (W-CDMA) network;

FIG. 2 illustrates an example method for establishing a data session in a network;

FIG. 3 illustrates an example method for applying a policy to a data session;

FIG. 4 illustrates an example TFT;

FIG. 5 illustrates an example method for applying one or more session access parameters to one or more data sessions;

FIG. 6 further illustrates the example method illustrated in FIG. 5; and

FIG. 7 illustrates an example computer system for applying one or more session access parameters to one or more data sessions.

### DESCRIPTION OF EXAMPLE EMBODIMENTS

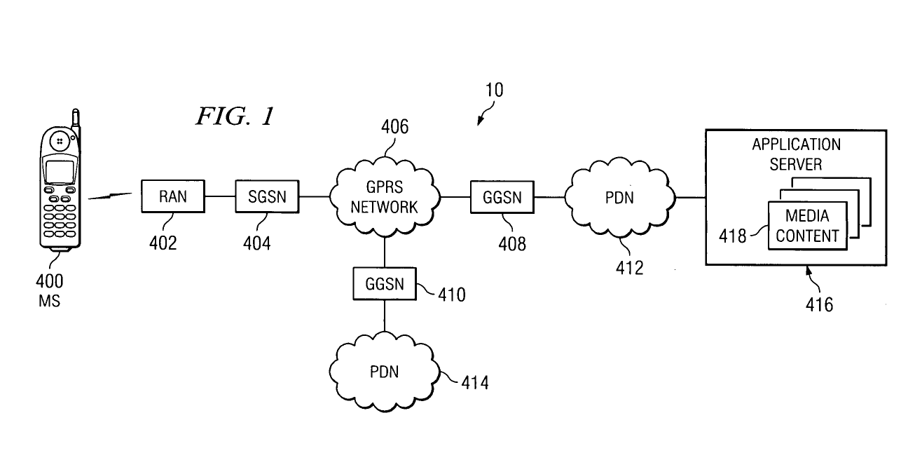

FIG. 1 illustrates an example W-CDMA network 10. In particular embodiments, one or more wireless communication links between mobile station (MS) 400 and Radio Access Network (RAN) 402 support wireless communication between MS 400 and RAN 402. As an example and not by way of limitation, an MS 400 may include a telephone, a personal digital assistant (PDA), a notebook computer system, or other MS 400. The present invention contemplates any suitable MS 400. The present invention contemplates any suitable wireless communication links between MS 400 and RAN 402. In particular embodiments, RAN 402 includes a base transceiver system, a base status controller, or both. One or more communication links between RAN 402 and Service GPRS Support Node (SGSN) 404 support communication between RAN 402 and SGSN 404. In particular embodiments, SGSN 404 is part of GPRS network 406. The present invention contemplates any suitable communication links between RAN 402 and SGSN 404. Reference to a “communication link” encompasses a wireline, optical, wireless, or other communication link or a combination of two or more such communication links, where appropriate. In particular embodiments, GPRS network 406 includes one or more GGSNs 408 and 410 that provide gateway functionality. GGSN 408 is a gateway to Packet Data Network (PDN) 412, and GGSN 410 is a gateway to PDN 414. PDNs 412 and 414 are packet networks, such as one or more portions of the Internet. The present invention contemplates any suitable PDNs. In particular embodiments, PDN 412 has a first Access Point Name (APN) that uniquely identifies PDN 412 and PDN 414 has a second APN that uniquely identifies PDN 414. One or more communication links couples PDN 412 to an application server 416 that provides application functionality, such as making media content 418 available to users. Although a particular W-CDMA network 10 including particular components in a particular arrangement communicating with each other in a particular manner is illustrated and described, the present invention contemplates any suitable W-CDMA network 10 including any suitable components in any suitable arrangement communicating with each other in any suitable manner. Moreover, although an example W-CDMA network 10 is illustrated and described, the present invention contemplates any suitable network.

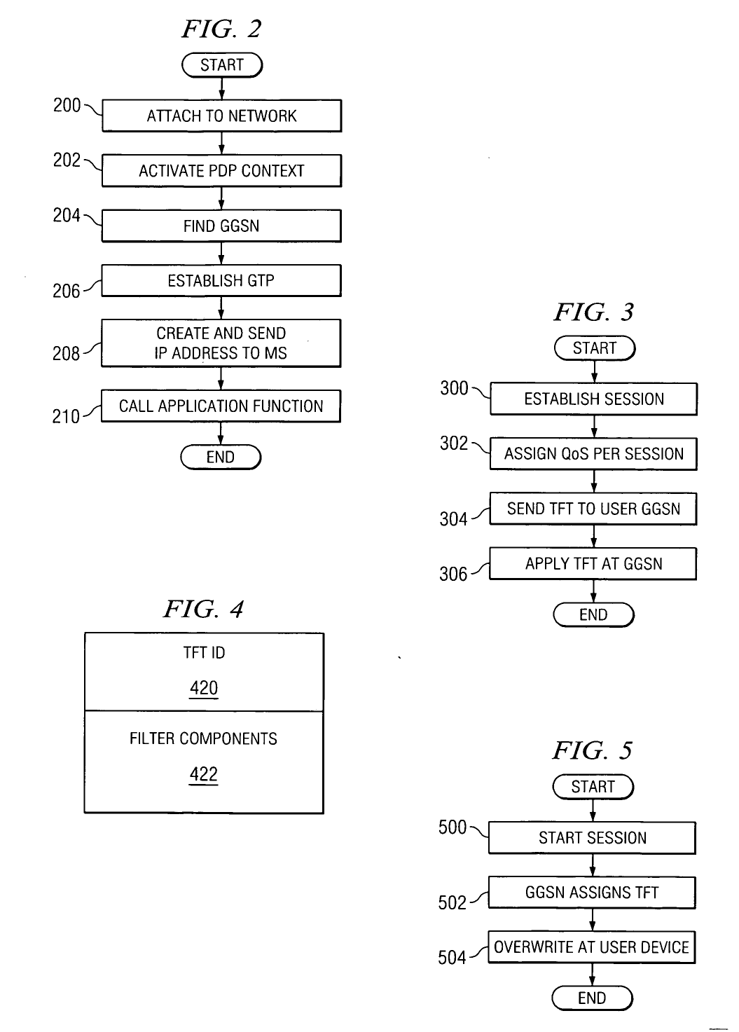

FIG. 2 illustrates an example method for establishing a data session in a network, such as W-CDMA network 10. Reference to a “data session” encompasses a data or other session, where appropriate. The method starts at step 200, where MS 400 attaches to W-CDMA network 10. As an example and not by way of limitation, to attach to W-CDMA network 10, MS 400 may connect to RAN 402 and carry out one or more initial connection and authentication processes, according to particular needs. At step 202, MS 400 activates a Packet Data Protocol (PDP) context to set up the data session. In particular embodiments, MS 400 communicates a request to SGSN 404 via RAN 402 that identifies one or more of the following: an APN of a preferred network, such as PDN 412 hosting application server 416; an Internet Protocol (IP) address of MS 400; a preferred Quality of Service (QoS) on the data session; routing information on the data session; and so on.

At step 204, according to the request, SGSN 404 identifies GGSN 408 providing access to PDN 412. In particular embodiments, SSGN 404 identifies a GGSN providing access to a home network of MS 400, depending on the preferred APN. In particular embodiments, to identify a GGSN according to the request, SGSN 404 carries out domain-name resolution using a domain-name server (DNS). In particular embodiments, MS 400 activates multiple PDP contexts to provide multiple services (such as web browsing and streaming content) to MS 400, to one or both of GGSNs 408 and 410, or both. At step 206, GPRS network 406 uses GPRS Tunneling Protocol (GTP) to establish a tunnel between SGSN 404 and GGSN 408. In particular embodiments, at step 206, GGSN 408 carries out one or more authentication and security processes. At step 208, GGSN 408 assigns an IP address to the data session and communicates the assigned IP address to MS 400. At step 210, MS 400 uses the assigned IP address to call one or more applications hosted at application server 416, at which point the data session is established and the method ends. Although particular steps of the method illustrated in FIG. 2 are illustrated and described as occurring in a particular order, the present invention contemplates any suitable steps of the method illustrated in FIG. 2 as occurring in any suitable order.

In particular embodiments, a policy including a set of session access parameters corresponds to the data session. As an example and not by way of limitation, the policy may be retrievable from an Authentication, Authorization, and Accounting (AAA) server that dictates session access parameters (such as bandwidth and latency) according to one or more application formations and service agreements between the user and the service provider. As an example and not by way of limitation, low latency (or delay) may be preferable in a voice or other real-time data session and the AAA server may determine one or more session access parameters of the policy according to the preference. The AAA server may apply a session access parameter such as “best effort” to e-mail traffic, which is not at time-sensitive as voice traffic. Reference to a “user” encompasses one or more end users, one or more other users, or both, where appropriate. Although particular session access parameters are described, the present invention contemplates any suitable session access parameters.

To access resources in W-CDMA network 10, MS 400 communicates specific flow template information to one or more components of W-CDMA network 10. As an example and not by way of limitation, a user may supply the information to MS 400 for purposes of determining access to one or more resources, such as one or more resources using real-time communication. In addition or as an alternative, a mobile operator providing administrative services may supply the information to MS 400. Particular embodiments implement TFTs to direct traffic to a data session according to one or more policies corresponding to the data session. Reference to a “TFT” may encompass one or more TFTs described in 3G TS 24.008, where appropriate.

FIG. 3 illustrates an example method for applying a policy to a data session. The method begins at step 300, where W-CDMA network 10 establishes a data session, as described above. A user (which may be a UMTS subscriber) may create multiple data sessions, or PDP contexts. Data sessions created by a user may share an IP address with each other and, at the same time, have QoS parameters that are different from each other and use data bearers that are different from each other. At step 302, W-CDMA network 10 assigns a QoS to each data session. W-CDMA network 10 steers traffic in a data session to a data bearer able to accommodate a QoS assigned to the data session, one or more access parameters assigned to the data session, or both. At step 304, an MS 400 of the user uses GTP to communicate a TFT of MS 400 to GGSN 408 via GPRS network 406. At step 306, GGSN 408 applies the TFT to the data session, at which point the method ends. Although particular steps of the method illustrated in FIG. 3 are illustrated and described as occurring in a particular order, the present invention contemplates any suitable steps of the method illustrated in FIG. 3 as occurring in any suitable order.

FIG. 4 illustrates an example TFT. In particular embodiments, a TFT includes a TFT identifier (ID) 420 and one or more filter components 422. As an example and not by way of limitation, filter components 422 may facilitate identification of IP traffic according to one or more fields (such as source address, type of service, and destination address) of packet headers. W-CDMA network 10 may, according to one more filter components 422 of the TFT, filter a packet having a particular destination port in a data session having a particular QoS and allocate the packet to a data bearer able to accommodate the QoS of the data session.

In particular embodiments, MS 400, GGSN 408, or both implement the TFT. In particular embodiments, MS 400 configures the TFT and communicates the TFT to GGSN 408 across GPRS network 406. GGSN 408 then applies the TFT to the data session. Applying the TFT at GGSN 408 provides the TFT at the uplink end relative to MS 400 and at the downlink end relative to GGSN 408, which facilitates directing traffic, in either direction, to an appropriate data session and an appropriate data bearer. In particular embodiments, TFTs facilitate multiple data sessions with QoSs that are different from each other taking place at the same time.

In particular embodiments, because configuration of a TFT is under the control of a user of an MS 400, GGSN 408 need not check the validity of a TFT. Providing TFTs to a large number of MSs 400 may be a complex and expensive task. Leaving configuration of TFTs to users may introduce security concerns. In particular embodiments, not checking the validity of a TFT before applying the TFT at GGSN 408 and obtaining an applicable policy from an AAA server gives rise to the possibility of misuse of the TFT, since the TFT is reconfigurable at an MS 400. Such reconfigurability enables a user to assign to a data session traffic matching one or more filter components 422 of a TFT associated with the data session, which may facilitate unauthorized traffic making use of data session.

In addition or as an alternative, particular embodiments define a Service-Based Local Policy (SBLP) to control access to resources in W-CDMA network 10. As an example and not by way of example, one or more such embodiments may define an SBLP according to one or more of 3G TS 23.207, 3G TS 29.207, and 3G TS 29.208. GGSN 408 ignores TFTs sent from MSs 400 and checks flows against one or more fields of a packet header (such as a destination address) according to policy-control information derived from a Policy Decision Function (PDF). A policy server associated with one or more applications accessed by an MS 400 during a data session may provide the PDF. As an example and not by way of limitation, a server associated with a home network of MS 400 may provide the PDF based on a service agreement between a user of MS 400 and the service provider making the application available to the user. In particular embodiments, use of an SBLP applies to only a specific set of applications, ignores TFTs, and requires interaction with a remote policy server.

Particular embodiments identify a policy server associated with a data session invoked, via a network access node, by an invoking node on a network. As an example and not by way of limitation, such embodiments may apply one or more session access parameters to a data session between a client device (such as an MS 400) and a host (such as application server 416) on a network (such as PDN 412) communicating with each other via a network gateway (such as GGSN 408). To apply the session access parameters to the data session, the network gateway may access a session connection parameter of the data session and derive a session flow filter from the session connection parameter. The session flow filter may include one or more session access parameters.

Particular embodiments allow GGSN 408 to control TFTs provided by MSs 400 to enhance control of network resources. FIG. 5 illustrates an example method for applying one or more session access parameters to one or more data sessions. The method begins at step 500, where W-CDMA network 10 establishes a data session having one or more session connection parameters (which may, as an example and not by way of limitation, include per-service parameters indicating, for example, a destination port, a source address, an APN, or two or more of the foregoing) identified by a TFT. GGSN 408 receives a session flow filter (which, in particular embodiments, includes the TFT) from an MS 400 attempting to communicate with a host (such as application server 416) on PDN 412 in the data session. In particular embodiments, GGSN 408 uses the TFT to apply appropriate session access parameters (such as one or more session access parameters indicating a particular QoS) to the data session. At step 502, GGSN 408 assigns the TFT to the data session. In particular embodiments, GGSN 408 includes one or more TFTs for checking against the TFT received from MS 400. GGSN 408 decides whether to reject the data session or accept the session and overwrite the TFT received from MS 400. At step 504, GGSN 408 has decided to accept the data session and overwrite the TFT received from MS 400 (instead of rejecting the data session) and, accordingly, generates a new TFT to overwrite the TFT received from MS 400 and communicates the new TFT to MS 400. As an alternative, in particular embodiments, GGSN 408 obtains one or more TFTs for checking against the TFT received from MS 400 from a device separate from GGSN 408. As an example and not by way of limitation, GGSN 408 may communicate information identifying MS 400, an APN, and the TFT received from MS 400 to an AAA server and request authorization on the data session from the AAA server. The AAA server may then decide whether to accept or reject the data session and the TFT. Although particular steps of the method illustrated in FIG. 5 are illustrated and described as occurring in a particular order, the present invention contemplates any suitable steps of the method illustrated in FIG. 5 as occurring in any suitable order.

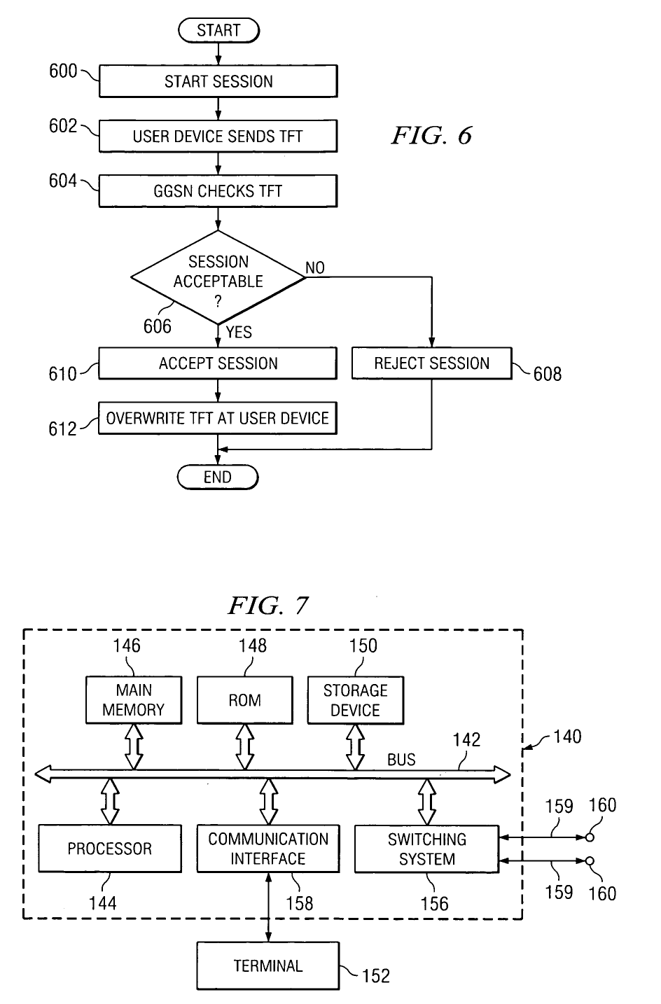

FIG. 6 further illustrates the example method illustrated in FIG. 5. The method begins at step 600, where W-CDMA network 10 establishes a data session between an MS 400 and application server 416, as described above. At step 602, MS 400 communicates to GGSN 408 a TFT that MS 400 intends to apply to the data session. The TFT then identifies the session connection parameters for filtering traffic. As an example and not by way of limitation, the session connection parameters may include one or more of one or more destination ports associated with MS 400, an APN, and one or more specific service details. At step 604, GGSN 408 attempts to verify the TFT communicated from MS 400. As an example and not by way of limitation, GGSN 408 may maintain a table of permissible TFTs that uses TFT IDs 420 and the data sessions the TFTs are applicable to. The table may identify data sessions by APN, service, or both. GGSN 408 uses session establishment information to identify the APN, service, or both. Reference to “session establishment information” encompasses information exchanged during a data session, where appropriate.

At step 606, GGSN 408 decides whether to accept the data session. If GGSN 408 decides at step 606 to reject the data session, the method proceeds to step 608, where GGSN 408 rejects the data session, at which point the method ends. If GGSN 408 decides at step 606 to accept the data session, the method proceeds to step 610, where GGSN 408 accepts the data session. At step 612, GGSN 408 overwrites the TFT at the MS 400, at which point the method ends. In particular embodiments, MS 400 includes a “dummy” TFT that requires no specific provision at the user end and relies on GGSN 408 for provision of the TFT, which may facilitate increased scalability. Although particular steps of the method illustrated in FIG. 6 are illustrated and described as occurring in a particular order, the present invention contemplates any suitable steps of the method illustrated in FIG. 6 as occurring in any suitable order.

As an alternative, in particular embodiments, GGSN 408 obtains a TFT from an AAA server remote from GGSN 408. GGSN 408 communicates information identifying one or more of MS 400, one or more services, an APN, and a TFT received during establishment of the data session to the AAA server and requests authorization. The AAA server then carries out steps 606, 608, 610, and 612 of the method illustrated in FIG. 6. In particular embodiments, the AAA server instructs GGSN 408 to accept or reject the data session and then communicates a TFT to GGSN 408. GGSN 408 then overwrites the TFT at MS 400 according to the TFT communicated by the AAA server.

The present invention contemplates any suitable form of template or filter and is not limited to TFTs. The present invention contemplates any suitable network and is not limited to a CDMA 2000 network that uses a Packet Data Serving Node (PDSN) providing gateway functionality. The present invention contemplates any suitable policy, any suitable level, and any suitable QoS. The present invention contemplates any suitable implementation of any suitable method of identifying, enforcing, or propagating services and policies. The present invention contemplates any suitable form of IP, such as IPv4, IPv6, and mobile IPv6.

FIG. 7 illustrates an example computer system 140 for applying one or more session access parameters to one or more data sessions. In particular embodiments, computer system 140 is a router or other computer system 140. Computer system 140 includes a bus 142 and a processor 144 coupled to bus 142. Computer system 140 also includes a main memory 146 coupled to bus 142. As an example and not by way of limitation, main memory 146 may include a random access memory (RAM), a flash memory, or another dynamic storage device. Main memory 146 stores data and instructions for execution at processor 144. In particular embodiments, main memory 146 also stores temporary variables or other intermediate data during execution of instructions at processor 144. Computer system 140 also includes a read only memory (ROM) 148 or other static storage device coupled to bus 142 for storing static data and instructions for execution at processor 144. Computer system 140 also includes a storage device 150 (such as a magnetic disk, flash memory, or optical disk) coupled to bus 142 for storing data and instructions.

Computer system 140 also includes a communication interface 158 coupled to bus 142. Communication interface 158 provides an interface between terminal 152 and one or more components (such as processor 144) of computer system 140. As an example and not by way of limitation, communication interface 158 may be a conventional serial interface, such as an RS-232 or RS-422 interface. Terminal 152 couples to computer system 140 and communicates commands to computer system 140 via communication interface 158. In particular embodiments, a hardware, software, or embedded-logic component or a combination of two or more such components at computer system 140 provides a terminal interface or character-based command interface that enables the communication of commands to computer system 140 from one or more devices external to computer system 140. Although a particular arrangement between computer system 140 and terminal 152 is illustrated and described, the present invention contemplates any suitable arrangement between computer system 140 and terminal 152. As an example and not by way of limitation, computer system 140 may wholly or partially include terminal 152.

Computer system 140 also includes a switching system 156 coupled to bus 142. Switching system 156 has input and output interfaces 159 to one or more network elements external to computer system 140. As an example and not by way of limitation, a network element external to computer system 140 may include one or more routers 160. As another example, a network element external to computer system 140 may include one or more local networks coupled to one or more hosts, routers or both. As yet another example, a network element external to computer system 140 may include one or more global networks, such as the Internet, including one or more servers. In particular embodiments, switching system 156 switches traffic arriving on an input interface 159 to an output interface 159 according to one or more predetermined protocols. As an example and not by way of limitation, switching system 156, in cooperation with processor 144, may determine a destination of a packet of data arriving on input interface 159 and use output interface 159 to communicate the packet to a destination. Example destinations include one or more hosts, one or more servers, one or more end stations, one or more routing or switching devices, and one or more other destinations. Although a particular computer system 140 including particular components operating in a particular environment is illustrated and described, the present invention contemplates any suitable computer system including any suitable components operating in any suitable environment.

In particular embodiments, computer system 140 provides one or more gateway functionalities. In particular embodiments, computer system 140 executes one or more steps of one or more of the methods illustrated in FIGS. 2-3 and 5-6 in response to processor 144 executing one or more instructions readable from main memory 146. One or more of the instructions may be read into main memory 146 from another computer-readable medium, such as storage device 150. In particular embodiments, one or more processors 144 in a multiprocessing arrangement are useable to execute instructions readable from main memory 146. In particular embodiments, a hardware or embedded logic component or a combination of two or more such components may execute one or more steps of one or more of the methods illustrated in FIGS. 2-3 and 5-6, in addition or as an alternative to software executing one or more steps of one or more of the methods illustrated in FIGS. 2-3 and 5-6. The present invention is not limited to any particular combination of hardware, software, and embedded logic.

Reference to “computer-readable medium” encompasses any medium that facilitates providing instructions for execution at processor 144, where appropriate. As an example and not by way of limitation, a computer-readable medium may include a nonvolatile, volatile, or transmission medium or a combination of two or more such media. As an example and not by way of limitation, nonvolatile media may include an optical or magnetic disk or a combination of two or more such disks. In particular embodiments, storage device 150 includes one or more nonvolatile media. As an example and not by way of limitation, volatile media may include dynamic memory. In particular embodiments, main memory 146 includes dynamic memory. As an example and not by way of limitation, transmission media may include a coaxial cable, a copper wire, a fiber cable, a portion of bus 142, or a combination of two or more such transmission media. As another example, transmission media may also include one or more wireless links, such as acoustic or electromagnetic waves generated during radio wave or infrared communication.

Examples of computer-readable media include, but are not limited to, floppy disks, flexible disks, hard disks, magnetic tapes, other magnetic media, CD-ROMs, other optical media, punch cards, paper tape, other physical media with patterns of holes, RAMs, PROMs, EPROMs, FLASH-EPROMs, other memory chip or cartridge, carrier waves, as described below, and other computer-readable media. Any suitable computer-readable media are useable to carrying one or more instructions to processor 144 for execution. As an example and not by way of limitation, a magnetic disk of a remote computer system may initially carry one or more of the instructions. The remote computer system may load the instructions into a dynamic memory and communicate one or more of the instructions over a telephone line using a modem, over one or more other communication links, or both. A modem local to computer system 140 may receive instructions and use an infrared transmitter to convert the instructions to an infrared signal. An infrared detector coupled to bus 142 may receive the instructions in the infrared signal and place the instructions on bus 142. Bus 142 may communicate the instructions to main memory 146. Processor 144 may retrieve the instructions from main memory 146 and then execute the instructions. Alternatively, storage device 150 may store one or more of the instructions before execution at processor 144, after execution at processor 144, or both. Reference to “instructions” encompasses instructions, data, or both, where appropriate. Reference to “data” encompasses data, instructions, or both, where appropriate.

In particular embodiments, interfaces 159 provide a two-way communication coupling to a communication link coupled to a local network. As an example and not by way of limitation, an interface 159 may be an integrated services digital network (ISDN) card or a modem. As another example, interface 159 may be a local area network (LAN) card. As another example, interface 159 may support one or more wireless communication links. A communication link to a local network may provide data communication through one or more networks to one or more other devices. As an example and not by way of limitation, the communication link may provide a connection through a local network to a host computer or to equipment operated by an Internet Service Provider (ISP). The ISP may provide communication services through the Internet. In particular embodiments, computer system 140 transmits and receives messages, which may include program code, through one or more local networks, one or more communication links, and one or more interfaces 159. As an example and not by way of limitation, a server may transmit requested code of an application through the Internet, ISP, local network, and communication interface 158. The application may facilitate execution of one or more steps of one or more of the methods illustrated in FIGS. 2-3 and 5-6. As computer system 140 receives the code, processor 144 may execute the code, storage device 150 may store the code for later execution, or both.

Particular embodiments have been used to describe the present invention, and a person having skill in the art may comprehend one or more changes, substitutions, variations, alterations, or modifications within the scope of the appended claims. The present invention encompasses all such changes, substitutions, variations, alterations, and modifications.

What is claimed is:

1. A method for applying one or more session access parameters to one or more data sessions, the method comprising:
obtaining one or more session connection parameters associated with a data session between a client device and a host coupled to each other via a network gateway; and
deriving one or more session flow filters from the session connection parameters associated with the data session.

2. The method of claim 1, comprising one or more of the network gateway and the client device obtaining the session connection parameters and deriving the session flow filters.

3. The method of claim 1, further comprising receiving one or more session flow filters from the client device and comparing the received session flow filters with the derived session flow filters.

4. The method of claim 1, further comprising applying the session flow filters to the data session.

5. The method of claim 4, comprising one or more of the network gateway and the client device applying the session flow filters to the data session.

6. The method of claim 1, wherein one or more of the session access parameters comprise a policy.

7. The method of claim 1, wherein one or more of the session connection parameter each comprise one or more of one or more access point names (APNs) and one or more session services.

8. The method of claim 1, wherein the network gateway comprises one or more of a General Packet Radio Server (GPRS) Gateway Support Node (GGSN) and a Packet Data Serving Node (PDSN).

9. The method of claim 1, wherein one or more of the session flow filters each comprise a Traffic Flow Template (TFT).

10. The method of claim 1, further comprising accessing the derived session flow filters at the network gateway to apply the derived session flow filters to the data session.

11. The method of claim 1, further comprising accessing the derived session flow filters at a server remote to the network gateway to apply the derived session flow filters to the data session.

12. The method of claim 1, further comprising assigning a flow to another data session according to the derived session flow filter.

13. Logic for applying one or more session access parameters to one or more data sessions, the logic being encoded in one or more media and when executed operable to:
obtain one or more session connection parameters associated with a data session between a client device and a host coupled to each other via a network gateway; and
derive one or more session flow filters from the session connection parameters associated with the data session.

14. The logic of claim 13, executable at one or more of the network gateway and the client device.

15. The logic of claim 13, further operable to receive one or more session flow filters from the client device and compare the received session flow filters with the derived session flow filters.

16. The logic of claim 13, further operable to apply the session flow filters to the data session.

17. The logic of claim 16, executable at one or more of the network gateway and the client device.

18. The logic of claim 13, wherein one or more of the session access parameters comprise a policy.

19. The logic of claim 13, wherein one or more of the session connection parameter each comprise one or more of one or more access point names (APNs) and one or more session services.

20. The logic of claim 13, wherein the network gateway comprises one or more of a General Packet Radio Server (GPRS) Gateway Support Node (GGSN) and a Packet Data Serving Node (PDSN).

21. The logic of claim 13, wherein one or more of the session flow filters each comprise a Traffic Flow Template (TFT).

22. The logic of claim 13, further operable to access the derived session flow filters at the network gateway to apply the derived session flow filters to the data session.

23. The logic of claim 13, further operable to access the derived session flow filters at a server remote to the network gateway to apply the derived session flow filters to the data session.

24. The logic of claim 13, further operable to assign a flow to another data session according to the derived session flow filter.

25. A system for applying one or more session access parameters to one or more data sessions, the system comprising:
means for obtaining one or more session connection parameters associated with a data session between a client device and a host coupled to each other via a network gateway; and
means for deriving one or more session flow filters from the session connection parameters associated with the data session.
